(19) United States
(12) Patent Application Publication
(10) Pub. No.: US 2004/0161501 A1
(43) Pub. Date: Aug. 19, 2004

(54) Methods of preparation of microwave pop-corn with low melt point oil packed in bags with high greaseproofness

(76) Inventor: Vladi Krumov Popov, Montreal (CA)

Correspondence Address: Vladi Popov, 37 ,Poruchik Dimitar Velichkov,, Plovdiv, 4000, BG

(21) Appl. No.: 10/368,025

(22) Filed: Feb. 19, 2003

(51) Int. Cl. A23L 1/36

(52) U.S. Cl. 426/93

(57) ABSTRACT

Microwave pop-corn are classified as semi-cooked food. With this patent is protected the utilization of oil such as coconut oil, soy-bean oil, palm oil, canola oil or their mixtures with a melt point between 23° and 38° C., the method of preliminary preparation, and homogenization of the products before their packing, different flavouring recipes and additional natural products, the one-layer packs or multiple-layers at least one of which is made of greaseproof paper with a degree of greaseproofness superior to 1800+/1800+, TAPPI T-454-05-96, in which the mixture is divided in equal parts, the pack may be with or without susceptor because of the low melt point, which contributes to obtain a regular liquid form of the oil.

### BACKGROUND OF THE INVENTION

Microwave pop-corn exists with components as basic products in the following quantities in weigh percents: corn 50 up to 70, partially hydrogenated soy-bean and cottonseed oil 25 up to 38, table-salt 1 up to 2.5, flavouring 6 up to 9.2 and colouring agent 0.54 up to 0.60. The flavouring includes: pizza, barbecue, meat/bacon/, tomato purée, sour cream, onion, sweet gum and essences of apple honey, apple, orange, grapes, margarita, whisky, cherry, mint.

Microwave pop-corn exists with components as basic products in the following quantities in weigh percents: corn 50 up to 70, partially hydrogenated soy-bean and cottonseed oil 25 up to 38, table-salt 1 up to 2.5, caramel flavouring 23 up to 32, flavouring 7 up to 9.2 and colouring agent 0.60 up to 0.67. The caramel flavouring includes: maize syrup, sugar, milk, maltodextrin, partially hydrogenated cocoa oil, natural and artificial essences. The flavourings are: pizza, barbecue, meat, tomato purée, sour cream, onion, sweet gum and essences of apple honey, apple, orange, grapes, margarita, whisky, cherry, mint.

Microwave pop-corn exists with components as basic products in the following quantities in weigh percents: corn 50 up to 70, partially hydrogenated soy-bean and cottonseed oil 25 up to 38, table-salt 1 up to 2.5, dehydrogenated cheese from the species Italian, Romano, parmesan, cheddar mixed with onion and garlic 7 up to 9.2

All the mentioned varieties of pop-corn have the following problems: a homogeneous colour of the product cannot be obtained This lowers its quality because colouring is added to the pop-corn by spreading it before putting into the microwave oven or by powdering when taking out of the microwave oven; a homogeneous flavouring of the product for the whole mass in the pack cannot be obtained which also lowers the quality because the spreading or the powdering of the flavouring cannot guaranty the same quantity in the product in the beginning of the process, its duration and at the and; a natural harmony of the taste qualities of the ready product cannot be obtained because of using essentially artificially obtained substances; the quantity of the basic product—the pop-corn in the ready product is low.

The used oil is basically hydrogenated soy-bean oil with a melt point of 40° C. the packages are with multiple layers, one of them being greaseproof paper with a low level of greaseproofness. Due to the high melt point the package is being added a succeptor which contributes to a better popping of the corn in their case. Aiming to reach indices such as high greaseproofness, people use to turn its back to the taste qualities of th-e product.

### SUMMARY

To overcome these problems, microwave pop-corn consisting of corn, oil, flavouring, table-salt and colouring for the food industry are created. According to the patent, the components as initial products are in the following quantities and weigh percents: corn 30 up to 90, oil such as cocoa, soy-bean, palm, canola, sunflower or their mixtures with a melt point of 23 up to 38° C. and a weigh percents of 10 up to 50, flavouring 1 up to 7 such as dried white brined cheese, yellow cheese, smoked cheese, pepper powder, milled paprika and cinnamon, table-salt 0.1 up to 3.0 or 30 to 55 weigh, percents, granulated sugar, granulated honey, caramel, maize syrup, lecithin and colouring for nutrition purposes 0.4 up to 1 of one of the following species: yellow, red, blue, orange, green, caramel. The flavouring can be caramel 30 up to 40 weigh percents, containing 80 up to 95 weigh percent of sugar, chocolate or cocoa powder 4 up to 15 and colouring 0.2 up to 1 weigh percents compared to the total mass of the product. The flavourings can be replaced by one of the following products which are 5 up to 15 weigh percents: peanuts, hazelnuts, walnuts, almonds, instead of salt caramel flavouring can be added 0.1 up to 3.0 weigh percents.

To obtain microwave pop-corn a preliminary treatment is necessary, mixing and packing. During the preliminary treatment the following operations are effectuated: the ingredients which ought to be cleaned are cleaned, then the different components are weighed, the oil melts according to the recipes at a temperature of 30-35° C. MIXING: All the weighed components are poured into the melt oil, its heating is interrupted and the mixture is stirred to obtain a homogeneous mixture and to lower the temperature to 25° C. PACKING: One-layer packs or multiple-layers at least one of which is greaseproof paper with a greaseproofness level higher than 1800+/1800+; TAPPT T-454-05-96 thickness in mm of 0.057+/−0.005 DIN EN 20534-08.93, wet-strength in percents 20+/−5 IN ISO 3781-10.94 are manufactures. The obtained homogeneous mass of the mixture is weighed for every pack, then is filled in mentioned above special greaseproof packs for nutritional purposes, the packs are closed, all the necessary information for the product are noted down on the packed product.

The Advantages of these kinds of microwave popcorn are:

there will be used low melt point oil without mixture, providing increase of the melt point

a homogeneous colouring of the ready product is obtained, because all its ingredients, including the flavouring and the colouring are added to the melt oleaginous mass when stirring.

a homogeneous flavouring of the ready proud for its whole mass in a pack is obtained because all the ingredients are added to the melt oleaginous mass when stirring.

a natural harmony of the taste qualities of the ready product is obtained because of the use of only natural products

The quantity of the essential ingredient of the ready product—the corn—is augmented.

The varieties of this product are multiplied because it is adapted to the preferences and taste of every connoisseur of quality food.

The one-layer or multiple-layers packing is a more esthetical using greaseproof paper with a degree of greaseproofness Superior to +1800/+1800 TAPPI T-454-05-96.

### EXAMPLES OF REALIZATION

### Example 1

Microwave pop-corn 1000 gr. Include the following ingredients as initial product in gr.:

| | |
|---|---|
| Corn | 696 gr. |
| Coconut oil with a melt point of 25° C. | 300 gr. |
| Table-salt | 2 gr. |
| Colouring | 2 gr. |

The mixture is packed in one-layer bags or multiple-layers at least one of which is greaseproof paper with a degree of greaseproofness superior to 1800+/1800+, TAPPI T-454-05-96

### Example 2

Microwave popcorn 1000 gr. Include the following ingredients as initial product in gr.:

| | | |
|---|---|---|
| Corn | 610 | gr. |
| Coconut oil with a melt point of 25° C. | 190 | gr. |
| Sugar | 135 | gr. |
| Glucose | 75 | gr. |
| Water | 35 | ml. |
| Lecithin | 0.4 | gr. |
| Cream or flavour | 1.4 | ml. |

The sum of the above-mentioned components is not equal to 1000 gr., and is always superior because of the evaporation processes when reaching the boiling point. The obtained mixture is divided in equal shares in one-layer bags or multiple-layers one of which is greaseproof paper with a greaseproofness superior to 1800+/1800+, TAPPI T-454-05-96

### Example 3

Microwave pop-corn 1000 gr. Include the following ingredients as initial product in gr.:

| | | |
|---|---|---|
| Corn | 530 | gr. |
| Coconut oil with a melt point of 25° C. | 161 | gr. |
| Sugar | 132 | gr. |
| Glucose | 75 | gr. |
| Water | 34 | ml. |
| Almonds | 112 | gr. |
| Lecithin | 0.55 | ml. |
| Cream or flavouring | 1.25 | ml. |

The sum of the above-mentioned components is not equal to 1000 gr., and is always superior because of the evaporation processes when reaching the boiling point. The obtained mixture is divided in equal shares in one-layer bags or multiple-layers one of which is greaseproof paper with a greaseproofness superior to 1800+/1800+, TAPPI T-4.54-05-96

I claim:

1. Microwave pop-corn consisting of corn, low melt point oil, flavouring, table-salt and colouring for alimentary purposes, with initial products in the following quantities and weigh percents:
corn 30 up to 90, oil such as coconut oil, soy-bean oil, canola, palm oil, sunflower oil or their mixtures with a melt point of 23° up to 38° C.-10 up to 50, flavouring 1 up to 7 such as dried feta cheese, smoked cheese, yellow cheese or a mixture of pepper, milled paprika and cinnamon, mixtures for barbecue and pizza, table salt 0.1 up to 3.0, granulated sugar, granulated honey, caramel, maize syrup, lecithin and colouring for alimentary purposes 0.4 up to 1 from one of the following species: yellow, red, blue, orange, green, caramel;
all this is packed in one-layer bags or multiple-layers at least one of which is made of greaseproof paper with a minimum greaseproofness level of 1800+/1800+ TAPPI T-454-05-96

2. The packed microwave pop-corn according to claim 1 can be with a susceptor or not, because the low melt point of the oil contributes to obtain a regular liquid form of the oil.

3. Microwave pop-corn according to claim 1, characteristic with the caramel flavouring in weigh percents 30 up to 40 including in weigh percents sugar 80 up to 95, cocoa or chocolate powder 4 up to 15 and colouring 0.2 up to 1 weigh percents of the total mass of the product.

4. Microwave pop-corn, according to claim 1, characteristic with the replacement of the flavouring by one of the following products which are 5 up to 15 weigh percents: peanuts, hazelnuts, walnuts, almonds, instead of salt caramel might be used 0.1 up to 3.0 weigh percents.
